(19) United States
(12) Patent Application Publication
(10) Pub. No.: US 2006/0179191 A1
(43) Pub. Date: Aug. 10, 2006

(54) Covert channel firewall

(76) Inventor: David Walter Young, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/056,540

(22) Filed: Feb. 10, 2005

(51) Int. Cl. G06F 13/00

(52) U.S. Cl. 710/107

(57) ABSTRACT

A method and apparatus for restricting an access operation on a bus cycle to a particular address range. The method may include receiving, by a controller hub, a cycle's address from a device and comparing the address against a valid address list stored in the controller hub to determine if the address is a valid address or an invalid address. The method also includes permitting or denying an access operation by the device based on whether the address is determined to be a valid address or invalid address, respectively.

### TECHNICAL FIELD

This invention relates to the field of platform architectures and, in particular, to a covert channel firewall.

### BACKGROUND

Computer systems typically include various platform devices, or input/output (I/O) devices, that operate under the control of one or more central processing units (CPU) through I/O buses. The CPUs typically communicate with the I/O devices using memory mapped I/O addressing. An I/O function is a specific job that an I/O device performs. An I/O device may host multiple I/O functions. Memory mapped I/O addressing involves assigning portions of the computer system memory to I/O functions as system memory address spaces. Reads and writes to those I/O addresses in system memory are interpreted as commands to the I/O function.

In computer systems, the CPUs may be under the control of a single operating system (OS) or multiple operating systems including a virtual machine (VM) OS. A VM may function as a self-contained platform, running its own VM operating system (also referred to as “guest operating system”). The VM, or guest, OS expects to operate as if it were running on a dedicated computer rather than a virtual machine, in its control of various events and hardware resources. The hardware resources may include processor-resident resources (e.g., control registers), resources that reside in memory and I/O devices.

An important aspect of a secure VM OS is that each virtual machine resides in a partition of system memory that needs to be secure from covert channel attacks by I/O devices from other partitions. That is, the guest operating systems in the VMs should be isolated such that no unauthorized communication channels can be established between them or with unauthorized external I/O bus agents.

A VM OS depends on a combination of hardware and software to establish isolation between guest operating systems. To work effectively, the VM is assumed to be aware of the system's functioning components, such as system memory and I/O addresses that are available on the specific platform on which the VM OS resides. If this assumption is correct, then the VM is able to install safeguards that prevent covert channel attacks between Virtual Machines and other bus agents.

There are natural forces in the engineering ecosystem that militate to keep such isolation from functioning properly. A number of poorly documented and even undocumented component registers and I/O addresses can creep into Memory and I/O Controller Hub designs. Often these addresses are the remaining vestiges of silicon validation efforts, or represent test ports that are required by various original equipment manufacturers (OEM), etc. The extremely large amount of logic that resides on a modern Memory and I/O Controller Hubs, and the generational method by which different teams of engineers contribute to the design, makes it nearly impossible to guarantee that unwanted registers, test points and device interfaces do not creep into the design.

### BRIEF DESCRIPTION OF THE DRAWINGS

The present invention is illustrated by way of example and not intended to be limited by the figures of the accompanying drawings.

FIG. 1 illustrates one embodiment of a platform architecture.

FIG. 2 is a flow chart illustrating one method of restricting an access operation to a particular address range.

FIG. 3 illustrates one embodiment of a controller hub that may be used to implement the method of FIG. 2 in the architecture of FIG. 1.

FIG. 4 illustrates one embodiment of a digital processing system having a valid address list resident in system memory.

FIG. 5 illustrates another embodiment of a digital processing system including a processor having a trusted code module.

FIG. 6 illustrates one embodiment of comparison circuit in the controller hub in FIG. 3.

### DETAILED DESCRIPTION

In the following description, numerous specific details are set forth such as examples of specific systems, techniques, components, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention may be provided as a computer program product, or software, that may include a machine-readable medium having stored thereon instructions, which may be used to program a computer system (or other electronic devices) to perform a process according to the present invention. A machine readable medium includes any mechanism for storing or transmitting information in a form (e.g., software, processing application) readable by a machine (e.g., a computer). The machine-readable medium may includes, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other type of medium suitable for storing electronic instructions.

The present invention may also be practiced in distributed computing environments where the machine readable medium is stored on and/or executed by more than one computer system. In addition, the information transferred between computer systems may either be pulled or pushed across the communication medium connecting the computer systems.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

A method and apparatus for restricting an access operation on a bus cycle to particular address ranges is described. In computing platforms, certain devices (e.g., processor, I/O device, etc.) have access operation cycle types. A cycle is composed of information (control and/or data) that is associated with a particular clock period on a bus. Cycle types include, for example, memory reads and writes (including VM, protected reads and writes, posted writes, etc.) and I/O reads and writes (including peer cycles between I/O devices). These cycle types can be restricted to pre-selected address ranges that are stored in a valid address list (VAL). The VAL may be stored, for example, in a controller hub coupled between one or more processors and one or more I/O devices in a given computing platform architecture. In one embodiment, the VAL may be authenticated (e.g., using RSA signatures) prior to storage in the controller hub. The previously authenticated VAL may be transmitted to controller hub, for example, by a BIOS memory or VM system software. The VM system software may use the queried VAL data to construct an isolation model for the platform, if desired.

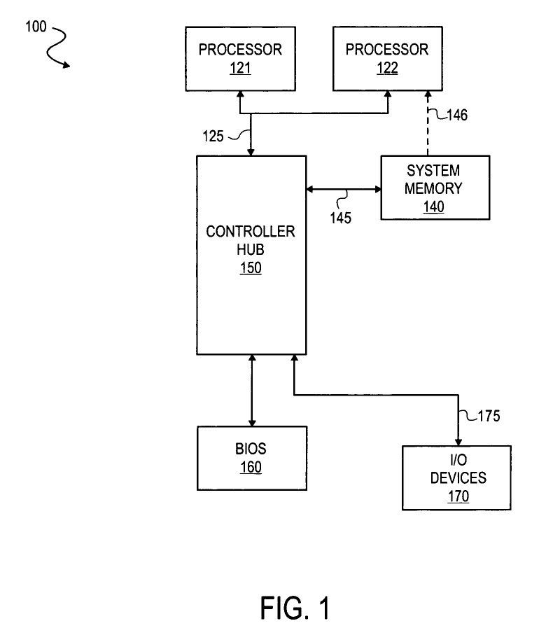

FIG. 1 illustrates one embodiment of a platform architecture in the form of a digital processing system representing an exemplary server, workstation, personal computer, laptop computer, handheld computer, personal digital assistant (PDA), wireless phone, television set-top box, etc., in which features of the present invention may be implemented. It should be noted that the architecture illustrated in FIG. 1 is only exemplary. In alternative embodiments, other platform architectures may be used for digital processing system 100.

In this embodiment, digital processing system 100 includes two or more processors 121 and 122, a controller hub (CH) 150, system memory 140, basic input/output start-up (BIOS) 160 and one or more I/O devices 170, and buses that carry data and addresses to the various components in system 100. The processors 121 and 122 may each reside on a different die substrate and in different chip packages. Alternatively, processors 121 and 122 may reside in a common chip package (referred to as multi-core) on separate integrated circuit die substrates or on a common die substrate. Processors 121 and 122 are coupled to the controller hub 150 with a multiple processor interface bus 125 (e.g., configurable system interconnect (CSI), front-side bus (FSB)). Processor 121 and 122 represent general purpose processors (e.g., central processing units (CPU), microprocessors) or special purpose processors (e.g., digital signal processors (DSP)), or other types of processing devices. More particularly, processors 121 and 122 may be complex instruction computer (CISC) microprocessors, reduced instruction set computing (RISC) microprocessors, very long instruction word (VLIW) microprocessors, processors implementing other instruction sets, or processors implementing a combination of instructions sets. Processors 121 and 122 are configured to execute the instructions for performing the operations and steps discussed herein. It should be noted that only two processors are illustrated in FIG. 1 for ease of discussion. In alternative embodiments, digital processing system 100 may include more or less than two processors.

Digital processing system 100 further includes system memory 140 that may include a random access memory (RAM), or other dynamic storage device, coupled to controller 150 for storing information and instructions to be executed by processors 121 and 122. In one embodiment, system memory 140 may be coupled directly to controller hub 150 using bus 145. In an alternative embodiment, system memory 140 may be coupled directly to one or more of processors 121 and 122 as indicated by the dashed bus line 146.

Digital processing system 100 requires at least one operating system in order for the platform to function. The operating system may be stored on one of the I/O devices 170. When digital processing system 100 boots (i.e., is started), a set of BIOS routines stored in BIOS memory 160 are executed by at least one of processors 121 and 122, which subsequently loads the operating system. Digital processing system 100 may also be capable of executing a VM operating system. Accordingly, processors 121 and 122 may be under the control of multiple operating systems including multiple VMs. A VM may function as a self-contained platform, running its own VM operating system or guest operating system. In one embodiment, the VMs may be implemented in software where each VM resides in a partition of system memory 140 that is secure from other partitions. VMs are known by those of ordinary skill in the art and may be implement in software, firmware, hardware or a combination therefore.

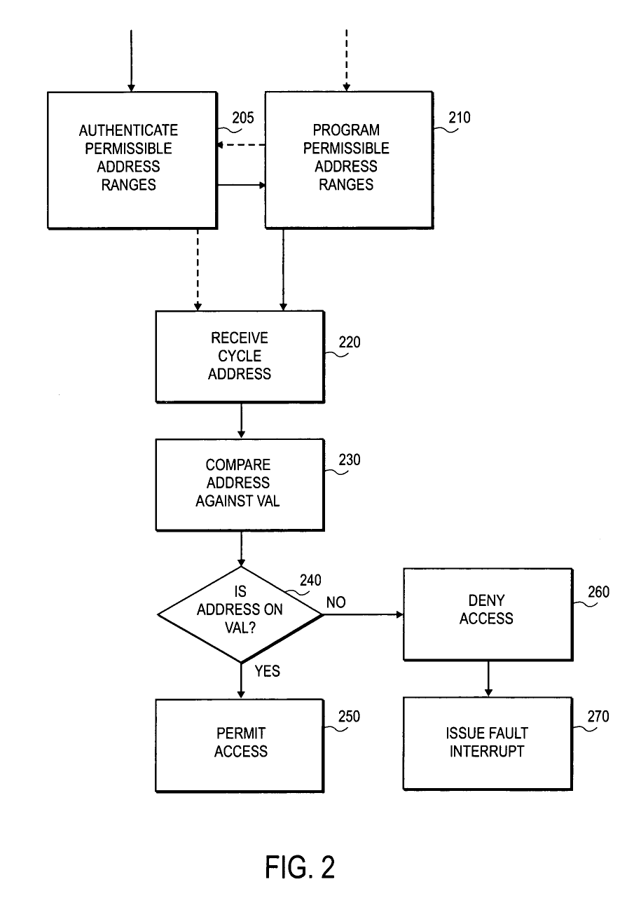

Controller hub 150 may be coupled to the processors 121 and 122, system memory 140, BIOS 160 and I/O devices 170. The controller hub 150 controls operations between the processors 121 and 122, the system memory 140, BIOS 160 and I/O devices 170. In one embodiment, controller hub 150 represents two components: a memory controller hub (MCH) and a separate I/O controller hub (ICH). A MCH is a component that may be used to control operations between processors 121 and 122 and the system memory 140. An ICH is a component that may be used to control operations between processors 121 and 122 and the I/O devices 170. Alternatively, the functions of a MCH and the ICH 230 may be integrated into a single controller hub 150. As discussed below in relation to FIG. 2, controller hub 150 may operate to restrict processor 121 and/or 122 to particular address ranges and cycle types. Alternatively, the controller hub 150 may operate to restrict cycle types of other types of devices, for example, peer cycles among I/O devices 170.

FIG. 2 is a flow chart illustrating one method of restricting an access operation to a particular address range. In this embodiment, the controller hub 150 may be programmed with a range of permissible addresses, step 210. In one embodiment, the controller hub 150 may be programmed with a previously authenticated valid address list. Alternatively, authentication may be performed on the range of permissible addresses after it is programmed into controller hub 150 in order to generate the valid address list (as indicated by the dashed lines in the flowchart of FIG. 2).

The method further includes receiving, by controller hub 150, an address on a cycle from a device (e.g., processor 121, processor 122, I/O devices 170), step 220. Next, the received address is compared against the valid address list, step 230. Based on the comparison in step 230, a determination is made based on the whether the address is on the valid address list (i.e., is a valid address or invalid address), step 240. If the address is on the valid address, the access cycle is permitted, step 250. Otherwise, the cycle is denied, step 260. In one embodiment, if the cycle is denied, a fault interrupt may be issued to the device attempting access.

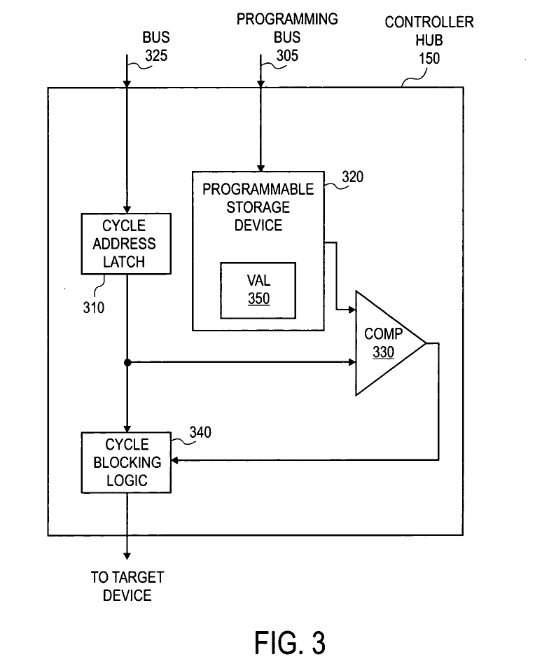

FIG. 3 illustrates one embodiment of a controller hub that may be used to implement the method of FIG. 2. In this embodiment, controller hub 150 may include an access bus 325, a programming bus 305, a cycle address latch 310, cycle block logic 340, programmable storage device 320, and comparison circuit 330. Access bus 325 is coupled to an accessing device and may represent, for example, bus 125 coupled to processor 121 and 122 or bus 175 coupled to I/O devices 170. In one embodiment, buses 305 and 325 may be the same bus.

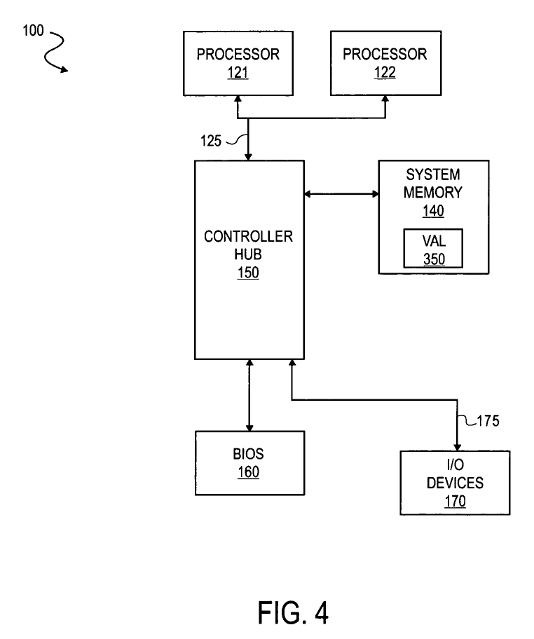

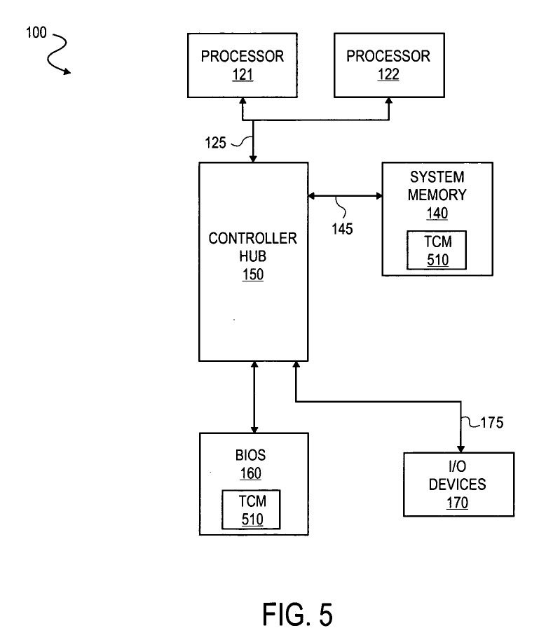

As discussed above with respect to FIG. 2, the programmable storage device 320 may be programmed with the ranges of permissible addresses and cycle types using programming bus 305. A programming device may be coupled to the programming bus 305 in order to programming storage device 320. In one embodiment, a previously authenticated VAL may be programmed into the storage device 320 by, for example, by VM system software or BIOS 160. For example, programming bus 305 may be coupled to system memory 140 with the programming performed by VM system software using a previously authenticated VAL 350 residing in system memory 140, as illustrated in FIG. 4. Alternatively, storage device 320 may be programmed initially with an unauthenticated address list and then subsequently authenticated. For example, programming bus 305 may be coupled to one of processors 121 and 122 with the authentication performed by an trusted code module (TCM) 510 residing as firmware in processor (e.g., processor 122 as illustrated in FIG. 5), with protected write cycles. The TCM 510 is a software module that is resistant to replacement or alteration by unauthorized agents. The TCM 510 is considered trusted, for example, because its code is provided in system memory 140 or resides in temper resistant flash such a boot block of BIOS 160, as illustrated in FIG. 5. The TCM 510 may also be actively re-authenticated periodically as part of hardware and/or a software security application that may be part of the secure OS.

After the storage device 320 has been programmed with the ranges of permissible addresses, then a protected cycle (e.g., from processor 121 or 122) can be used to ensure that the storage device 320 contains only a list of valid addresses (i.e., the valid address list). In one embodiment, for example, during an initialization process, the permissible address ranges may be read to generate a hashed list using a hash algorithm. The hashed list may be compared with the VAL stored in the trusted code module 510 using a decrypted (e.g., RSA) signature to determine if there is a match. If so, the VAL programmed in storage device 320 is authenticated. Trusted code techniques, hash algorithms, and encryption signatures are known in the art; accordingly, a detailed description is not provided.

After the VAL 350 is resident in storage device 320, an access operation may be performed through controller hub 150. An access cycle's target address is received on bus 325 by cycle address latch 310. A comparison circuit (COMP) 330 is coupled to both cycle address latch 310 and the programmable storage device 320. The comparison circuit 330 operates to observe bus cycles as they are passing through the controller hub 150 and compare them against the VAL 350 stored in the controller hub 150. In particular, the comparison circuit 330 compares the address in latch 310 and against the VAL 350 in programmable storage device 320 to determine whether there is a match. In one embodiment, the cycle's type (e.g., write, read, etc.) may also be compared against cycle types stored in a table (i.e., programmable storage device 320) associated with a permissible address range. If a match exits, the comparison circuit 330 outputs a control signal to cycle blocking logic 340 indicating whether the address was within a permissible address range of the VAL. The cycle blocking logic 340 is coupled to receive the address from the cycle address latch 310 and deny or permit access to the target device (e.g., I/O device 170) based on the output of the comparison circuit 330 indicating that the address is an invalid address or valid address, respectively. If the cycle's target address is not on the VAL 350, then the cycle's operation is blocked by cycle blocking logic 340. In one embodiment, the controller hub 150 may assert a fault condition to the device that originated the bus cycle (e.g., processor 121).

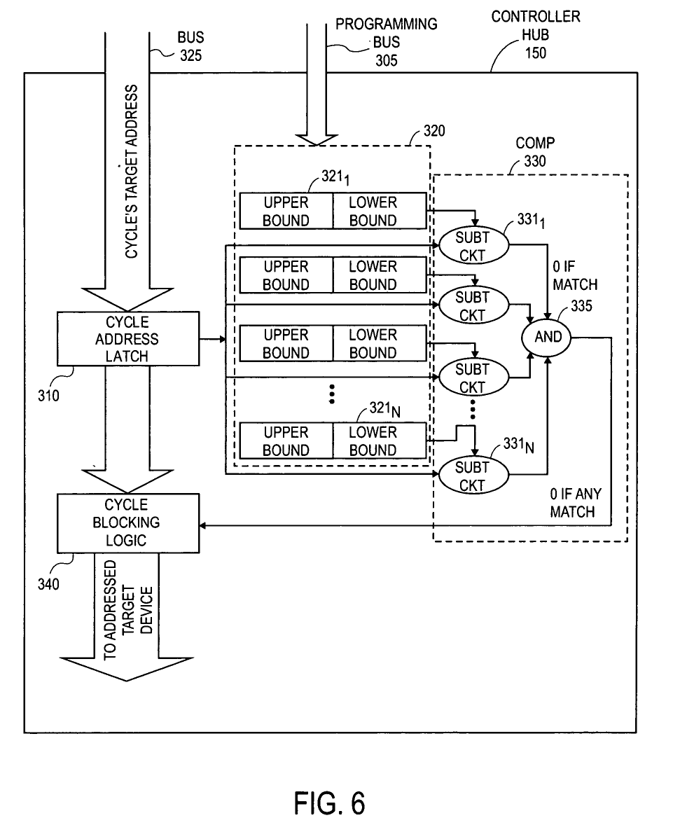

FIG. 6 illustrates one embodiment of comparison circuit in the controller hub of FIG. 3. In this embodiment, the programmable storage device 320 that stores the VAL may be implemented with a group of registers 321₁ to 321_{N} . The comparison circuit 330 may comprised of a group of subtraction circuits 321₁ to 321_{N} that are coupled to an AND logic circuit 335. The control registers 321₁ to 321_{N} store the upper and lower bound of the permissible address ranges and are coupled to the subtraction circuits 321₁ to 321_{N} , respectively. In the comparison operation, in one embodiment, the subtraction circuits 321₁ to 321_{N} are used to determine whether a carry bit equal to “1” results when subtracting a cycle address from the upper bound of any of the permissible address ranges. If not, then the lower bounds of the permissible address ranges are subtracted from the cycle address. The output of the subtraction circuits 321₁ to 321_{N} are coupled to the AND logic 335. If there is no “1” carry bit (i.e., a “0” bit) from any of the subtract circuits, then AND logic 335 outputs a “0” to the cycle blocking logic 340 in order to allow the address to pass. In one embodiment, the cycle blocking logic 340 takes the output from the AND logic 335 and performs a logic operation with an appropriate cycle present indicator that is received from the originating device (e.g., on bus 325) in order to block or allow the address to pass. It should be noted that operations of the comparison circuit 330 may be implemented using other logic configurations (e.g., “0” and “1” bits switched) and operations. A latch, programmable storage device, subtraction circuit, and logic blocks are known to one of ordinary skill in the art; accordingly, a more detailed discussion of these components is not provided.

Conceptually, the comparison operation synchronously scans bit positions between the cycle address and the permissible address ranges that are the operands. Then, where a first operand that contains a “1” bit at the scanned position and where the other operand contains a 0 bit at the same position, the first operand is larger. The inverse is true if the first operand contained the first 0 bit and the second operand contained the “1” bit. In the first instance, a check is made that the upper bound of the permissible address range is greater than or equal to the cycle address. A simultaneous check may also be made that the lower bound of the permissible address range is less than or equal to the cycle address. Alternatively, other methods may be used for scanning bit positions to find the first borrow position moving form high order to low order and then to quit asserting a “0” for each boundary limit test if the cycle address is within the bounds of the boundary address.

It should be noted that current CPUs may employ cycle types to restrict access of I/O devices by CPU internal logic or by privileged applications. By using programmable registers in the controller hub, future processors may, for example, assign cycle types to VM partitions to fit their own flexible protection model. In particular, the methods and apparatus discussed above provide a means for establishing a covert channel firewall to prevent an establishment of a non-architectural communication channel between the partitions by limiting cycles to device address that are authenticated by addresses in the programmable registers. System designers may be able to add ad-hoc design features late in a system design phase without the worry of needing to add additional feature enable fuses or undergoing security reviews while they are attempting to focus on debugging functionality and improving performance.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
an address latch to store an address;
a plurality of programmable registers; and
a comparator coupled to the address latch and the plurality of programmable registers to compare the address stored in the address latch against a valid address list stored in the programmable registers, the comparator to output a controller signal.

2. The apparatus of claim 1, further comprising a cycle blocking circuit coupled to the address latch to receive the address and the comparator to receive the controller signal, the cycle blocking circuit to output the address based on a value of the control signal.

3. The apparatus of claim 2, wherein the cycle blocking circuit comprises a latch.

4. A controller hub comprising the apparatus of claim 2.

5. An apparatus, comprising:
a plurality of devices; and
a controller hub coupled to the plurality of devices, wherein the controller hub comprises:
an address latch to store an address;
a plurality of programmable registers;
a comparator coupled to the address latch and the plurality of programmable registers to compare the address stored in the address latch against a valid address list stored in the programmable registers, the comparator to output a controller signal; and
a cycle blocking circuit coupled to the address latch to receive the address and the comparator to receive the controller signal, the cycle blocking circuit to output the address based on a value of the control signal.

6. The apparatus of claim 5, wherein the plurality of devices comprises a plurality of processors, one of the plurality of processors to transmit the address to the address latch.

7. The apparatus of claim 6, wherein the plurality of processors resides in a common chip package.

8. The apparatus of claim 6, wherein each of the plurality of processors reside in a different chip package.

9. The apparatus of claim 5, wherein the plurality of devices comprises a plurality of I/O devices, one of the plurality of I/O devices to transmit the address to the address latch or to receive the address output from the cycle blocking circuit.

10. The apparatus of claim 5, wherein the plurality of devices comprises a processor to transmit the address to the address latch and an I/O device to receive the address output from the cycle blocking circuit.

11. The apparatus of claim 5, further comprising a memory coupled to the controller hub to store the valid address list.

12. The apparatus of claim 11, wherein the memory is a system memory.

13. The apparatus of claim 11, wherein the memory is a BIOS memory.

14. The apparatus of claim 5, wherein the controller hub comprises a memory controller hub and an I/O controller hub.

15. The apparatus of claim 5, further comprising a memory to store virtual machine software.

16. The apparatus of claim 11, wherein the memory stores a trusted code module.

17. An apparatus, comprising:
means for establishing partitions in one or more processors; and
means for establishing a covert channel firewall between partitions to prevent an establishment of a non-architectural communication channel between the partitions.

18. The apparatus of claim 17, wherein the means for preventing comprises means for limiting cycles to device addresses that are authenticated by the apparatus.

19. The apparatus of claim 18, wherein the means for limiting comprises a valid address list residing in a controller hub of the apparatus.

20. A method, comprising:
receiving, by a controller hub, an address of a cycle from a device;
comparing the address against a valid address list stored in the controller hub to determine if the address is a valid address or an invalid address; and
permitting or denying an access operation by the device based on whether the address is determined to be a valid address or invalid address, respectively.

21. The method of claim 20, wherein the device is a processor.

22. The method of claim 20, wherein the device is an I/O device.

23. The method of claim 20, further comprising aborting the access operation if the address is determined to be an invalid address.

24. The method of claim 23, further comprising issuing a fault interrupt to the processor if the address is determined to be an invalid address.

25. The method of claim 20, further comprising programming the controller hub with the valid address list.

26. The method of claim 20, further comprising programming the controller hub with a plurality of permissible addresses.

27. The method of claim 26, further comprising authenticating the plurality of permissible addresses to generate the valid address list.

28. The method of claim 20, further comprising:
receiving, by the controller hub, the valid address list; and
storing the valid address list in the controller hub.

29. The method of claim 28, wherein the valid address list is received by the controller hub from a BIOS memory or a virtual machine system software.

30. The method of claim 28, wherein the valid address list comprises
permissible address ranges and wherein storing comprises programming a
plurality of registers in the controller hub with the permissible address ranges.
